(19) United States
(12) Patent Application Publication
(10) Pub. No.: US 2019/0019479 A1
(43) Pub. Date: Jan. 17, 2019

(54) Snap-on drum clip sound enhancer for a percussion instrument

(71) Applicant: Mathew Ephram Strickland, Burlingame, CA (US)

(72) Inventor: Mathew Ephram Strickland, Burlingame, CA (US)

(21) Appl. No.: 15/731,692

(22) Filed: Jul. 17, 2017

(51) Int. Cl. G10D 13/02; F16B 2/22

(52) U.S. Cl. CPC G10D 13/022; F16B 2/22

(57) ABSTRACT

The invention is a sound enhancing device for use with a percussion instrument. This clip-on drum enhancing device is comprised of a rigid clip and at least one surface coming in contact with the drum heads vibrating surface. Once assembled, the clip and chosen sound enhancer can be selectively secured to the hoop of a drum. These sound modifying devices come in contact with the drums vibrating head to produce: less ring, lower drum pitch, added high frequencies, tambourine sounds, bead sounds, triggered drum sounds, or any new combination of materials that help enhance the drum sound when struck. These clip-on sound enhancers can come in the form of: leather with magnets for altering amount of dampening, plastic PET film that can be cut to size for altering amount of dampening, PET film layers that cover part or all of the drum head surface and one that is purposefully struck by the drummer to lower drum pitch, metal wire used to add high frequency when drum head is struck, beads used to add sustain, tambourines used to add jingle, and electronic triggers that sense the head vibration and send a pulse to an external drum sound of the drummers choice.

### CROSS-REFERENCE TO RELATED APPLICATIONS

This application is a continuation in part of U.S. patent application Ser. No. 15/226,868, filed on 2015 Aug. 5 currently U.S. Pat. No. 9,711,116 which application is incorporated by reference as though fully contained herein:

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of music. More particularly, the present invention is in the technical field of sound modification. More particularly, the present invention is in the technical field of sound enhancing devices for any percussion instrument.

### PRIOR ART

1. Sound modification device for a percussion instrument

U.S. Pat. No. 8,541,675 B2

Mathew Ephram Strickland Sep. 30, 2009

2. Muting and muffling of drums

U.S. Pat. No. 4,567,807

Robinson David F Nov. 29, 1982

3. Dampening device for a percussion instrument

U.S. Pat. No. 6,696,630 B2

Robert A. Gatzen Feb. 34, 2004

4. Sound modification system

United States Patent Application 20070056428

Kind Code A1

May; James H. JR. Mar. 15, 2007

### 5. DRUM HOOP CLAMP

United States Patent Application US 2014/0123831 A1

Kind Code A1

Ronn Dunnett, Delta (CA) May 8, 2014

### 6. Drum Resonance Eliminator

U.S. Pat. No. 4,671,158 A

Peter, Saputo Jun. 1987

### SUMMARY OF THE INVENTION

The Snap-On Drum Clip Sound Enhancer is an invention that secures sound altering devices to a drum. It is comprised of at least one flexible surface that is both attached to the ridged clip and will extend to become the sound altering device that comes in contact with the vibrating drumhead. Said flexible surface is secured along the inner area of the rigid clip, and extends beyond each side of said rigid clip. One extension results in a gripping tab, and the other extension results in the sound altering device that comes in contact with the vibrating drumhead. The sound altering end of the flexible surface either changes the sound produced by the drum or supplements that sound by producing a sound of its own. In one embodiment, the end of the flexible surface that comes in contact with the drumhead modifies the sound of the drum when the drumhead is struck. In another embodiment, the end of the flexible surface that comes in contact with the drumhead modifies the sound of the drum when the flexible surface itself is struck.

### BRIEF DESCRIPTION OF DRAWINGS

FIG. 1 is an exploded view of the Snap-On Drum Clip Sound Enhancer;

FIG. 2 is a perspective view of on embodiment of the rigid clip of the Snap-On Drum Clip Sound Enhancer;

FIG. 3 is a close up perspective view of the magnet within said Snap-On Drum Clip Sound Enhancer;

FIG. 4 is a perspective view of one embodiment of an assembled Snap-On Drum Clip Sound Enhancer attached to rim of drum;

FIG. 5 is a perspective view of the change in damper size of the Snap-On Drum Clip Sound Enhancer using the ferrous rivets to magnet;

FIG. 6 is a perspective view of the storing of the Snap-On Drum Clip Sound Enhancer to the hoop of the drum within the scope of a full sized drum;

FIG. 7 is a perspective view of another embodiment of the intentional lifting “gated” open and closed flexible surface movement of the Snap-On Drum Clip Sound Enhancer;

FIG. 8 is a perspective view of alternate flexible surface embodiments utilizing different shapes of the Snap-On Drum Clip Sound Enhancer.

FIG. 9 is a close-up perspective of the Snap-On Drum Clip Sound Enhancer component in the closed position;

FIG. 10 is a close-up perspective of the Snap-On Drum Clip Sound Enhancer component in an open position;

FIG. 11 is a top view of another embodiment of the Snap-On Drum Clip Sound Enhancer showing the overlapping feature;

FIG. 12 is a top view of another embodiment of the Snap-On Drum Clip Sound Enhancer showing different sizes of the sound altering component that have been created by the drummer cutting the damper using the dashed lines provided;

FIG. 13 is a top view of another embodiment showing the Snap-On Drum Clip Sound Enhancer coming in contact with the drumhead, modifying the sound of the drum when the drumhead is struck. This demonstrates the pitch change capabilities utilizing different thicknesses and sizes of the flexible surface as well as a stacking feature showing multiple surfaces on top of the same drumhead;

FIG. 14 is a top view of another embodiment of the Snap-On Drum Clip Sound Enhancer showing different sound altering components incorporating tambourines, beads, and snare wire strainers as well as different ways of securing these features off the drum for storage;

FIG. 15 is a top view of another embodiment of the Snap-On Drum Clip Sound Enhancer incorporating a drum trigger sensor, an alternate clip shape, and a microphone holder;

FIG. 16 is a top view of another embodiment of the Snap-On Drum Clip Sound Enhancer showing hook and look and button flexible attachments to the Snap-On clip body;

### DETAILED DESCRIPTION OF THE INVENTION

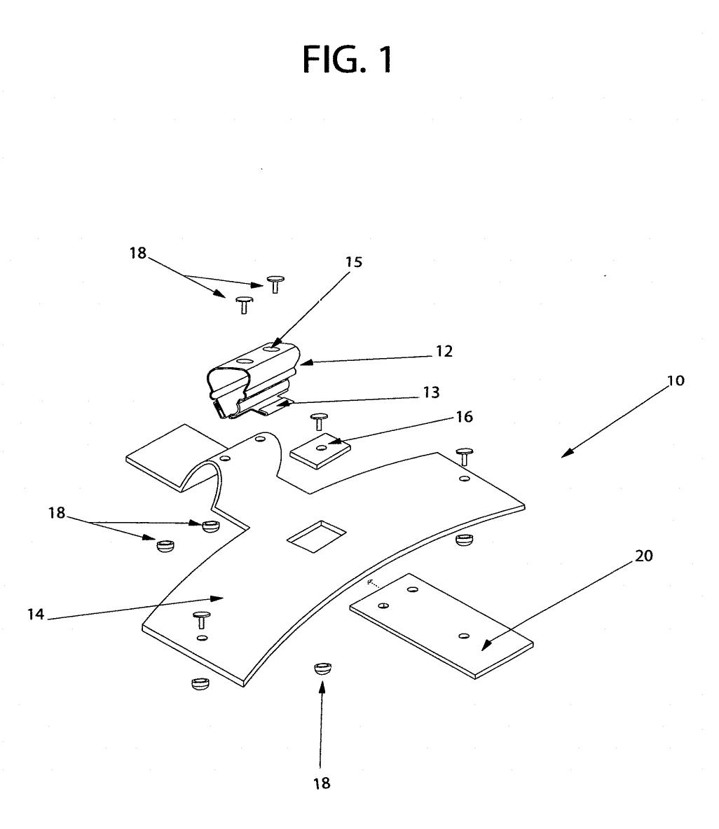

Referring now to the Snap-On Drum Clip Sound Enhancer in more detail in FIG. 1; FIG. 1 is an exploded view according to one embodiment of the present invention and is not intended to limit the scope of the present invention. The Snap-On Drum Clip Sound Enhancer 10 is shown having a list of parts: clip 12 flexible surface 14 magnet 16 rivets 18 protrusion 13 and the firmer flexible surface 20. The present device will be described more with a series of different embodiments in FIGS. 1 through 16.

in further detail, still referring to the Snap-On Drum Clip Sound Enhancer of FIG. 1; the rigid clip 12 may be wood, stone, hard plastic, rubber, alloy, or any sufficiently durable surface, but most preferably spring steel. The rigid clip 12 could be wavy, flat, holed, angled, textured, or any combination of these, but most preferably a smooth surface with a protrusion 13 that prevents the clip from becoming stuck between the drum head and the drum rim. The flexible surface 14 could be PET film, plastic, fabric, cotton, synthetic leather, vinyl, metal, fabric or any combination of these materials. The flexible surface 14 could be of any size and comprised of any number of sound enhancing materials such as: tambourines, shakers, beads, snare strainer wire, drum triggers, metal, or sand.

The construction details of the Snap-On Drum Clip Sound Enhancer as shown in FIG. 1; The form of the rigid clip 12 may be any shape: oval, round, square, triangular, etc, but preferably rectangular in shape. The size of the rigid clip 12 could be, but is not limited to, 14 mm wide×30 mm long×.30 mm thick. The flexible surface 14 could be constructed out of one or more pieces of leather or a combination of leather, metal, plastic PET film or both. The flexible surface 14 could be selectively secured to a ferrous material with a magnet 16 or hook and loop or button in the said damper. The flexible surface 14 could be attached to the rigid clip 12 by glue, screws, button, or hook and loop or a rivet 18. The flexible surface 14 could be at least one piece of leather, plastic, or PET film or combination, and arranged in any way with the magnet 16 but preferably in the center of flexible surface 14. The shape 13 protrudes from the clip 12 as to prevent the clip 12 from getting wedged between the shell and hoop of the drum.

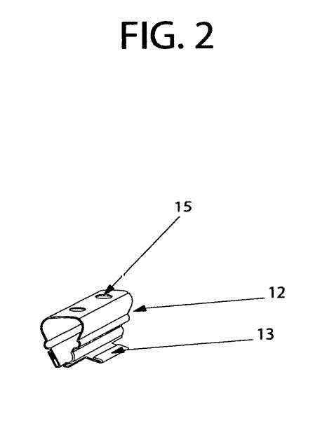

Referring now to the clip in FIG. 2; which shows one perspective view of the rigid clip 12. The construction details of the damper as shown in FIG. 2; the rigid clip 12 is constructed of one or more pieces of material, preferably spring steel. It can have holes 15 to accept rivets for attaching the dampening or sound enhancing devices. The shape 13 protrudes as to prevent the snap on clip 12 from getting wedged between the shell and hoop of the drum.

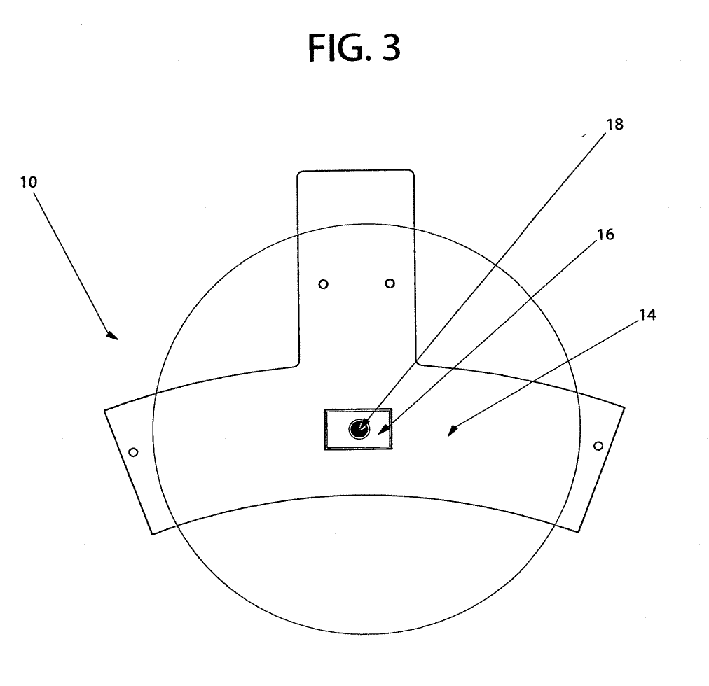

Referring now to FIG. 3; shows an embodiment of the Snap-On Drum Clip Sound Enhancer 10 with the magnet 16 shown in the center of the flexible surface 14. The magnet 16 could be any shape or thickness that best works with this device. The magnet 16 could be glued, riveted, screwed, or adhered in any way to the flexible surface 14 but preferably riveted 18.

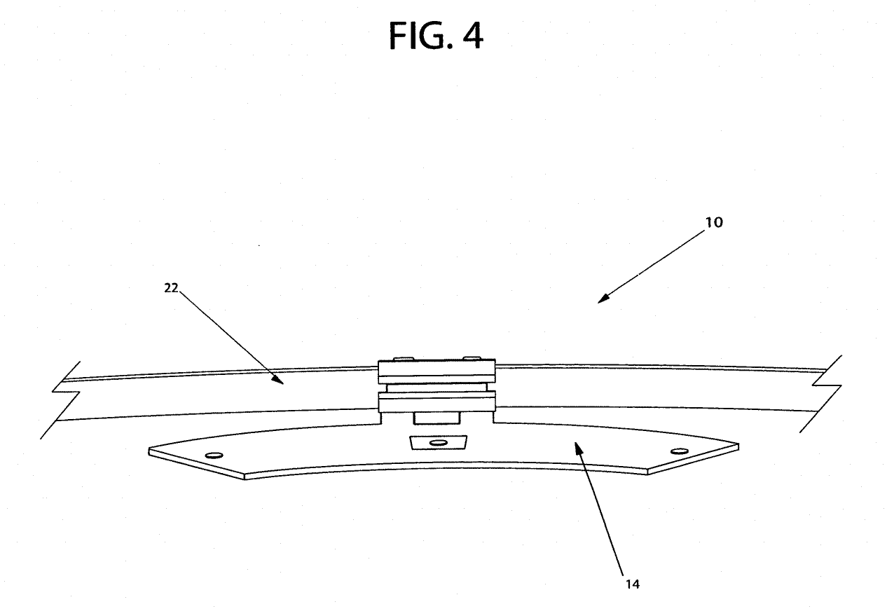

Referring now to FIG. 4; Still referring to the Snap On Drum Clip Sound Enhancer 10 the length of the perimeter of the flexible surface 14 could be curved or straight in a way to conform to the inside shape of a standard snare drum rim 22.

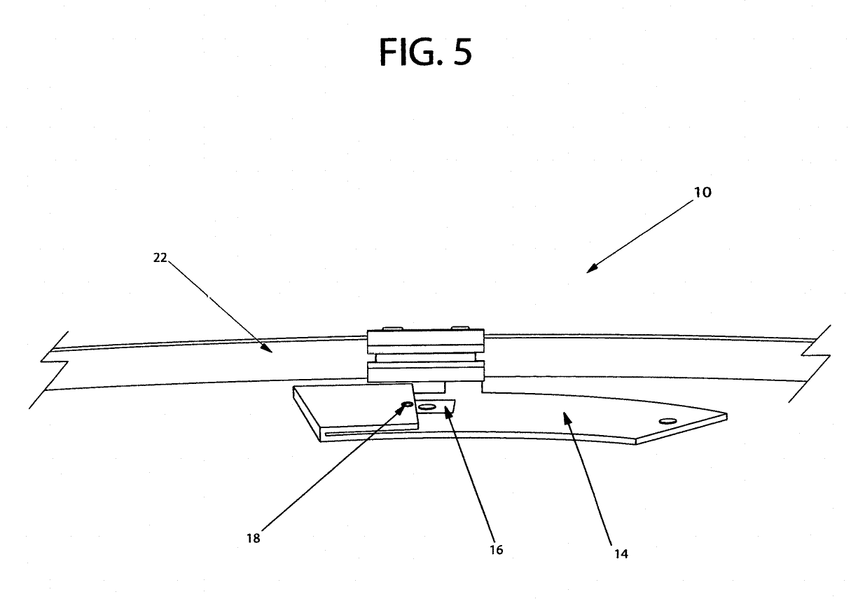

Referring now to FIG. 5; any portion of flexible surface 14 can include ferrous materials like rivets 18 to help remove and adhere portions of flexible surface 14 to magnet 16 thus changing the size of the Snap-On Drum Clip Sound Enhancer 10. Within the scope of the construction of this invention, in addition to magnet 16, there could be other on/off fasteners comprised of: hook and loop, buttons, zippers and any other fasteners which could be used to change the amount of flexible dampening component that comes into contact with the drumhead.

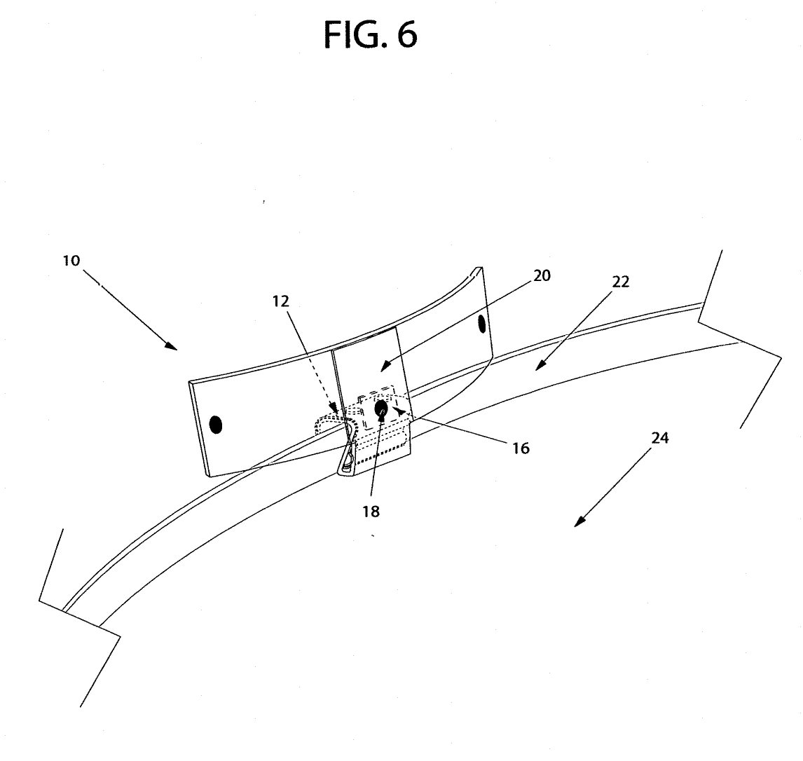

Referring now to FIG. 6; shows the Snap-On Drum Clip Sound Enhancer 10 being stored above the rim 22 of vibrating area of said drumhead 24 with use of ferrous clip 12 and magnet 16. Further construction details show the thinner firmer flexible surface 20 attached to the main leather body and supporting the weight of the flexible surface 14 and magnet 16 held on by the rivet 18.

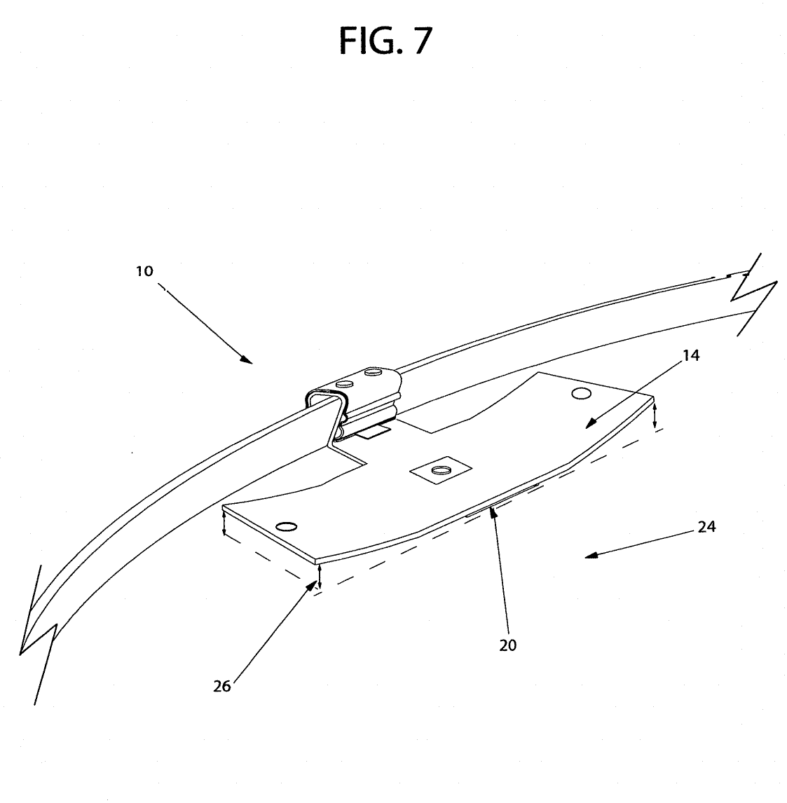

Referring now to FIG. 7; is a perspective view of the intentional opening and closing movement 26 of the flexible surface 14 of the Snap-On Drum Clip Sound Enhancer 10 vibrating up and away from surface of said drum 24 lessening the dampening properties. The amount of lift of the flexible surface 14 is dependent on the force produced by hitting said drumhead 24, and the density and/or thickness of materials used in said flexible surface 14. The construction details of the Snap-On Drum Clip Sound Enhancer 10 can be such that an adhered alternate flexible surface 20 can be sized to give firmness under the Snap-On Drum Clip Sound Enhancer 10, preventing lift of the flexible surface 14 from the area to which it was added but extending lift to the lighter and more flexible parts of the flexible surface. This alternate flexible surface 20 is used to help grip the rim 22 with friction, keeping it stable and in position on the rim 22.

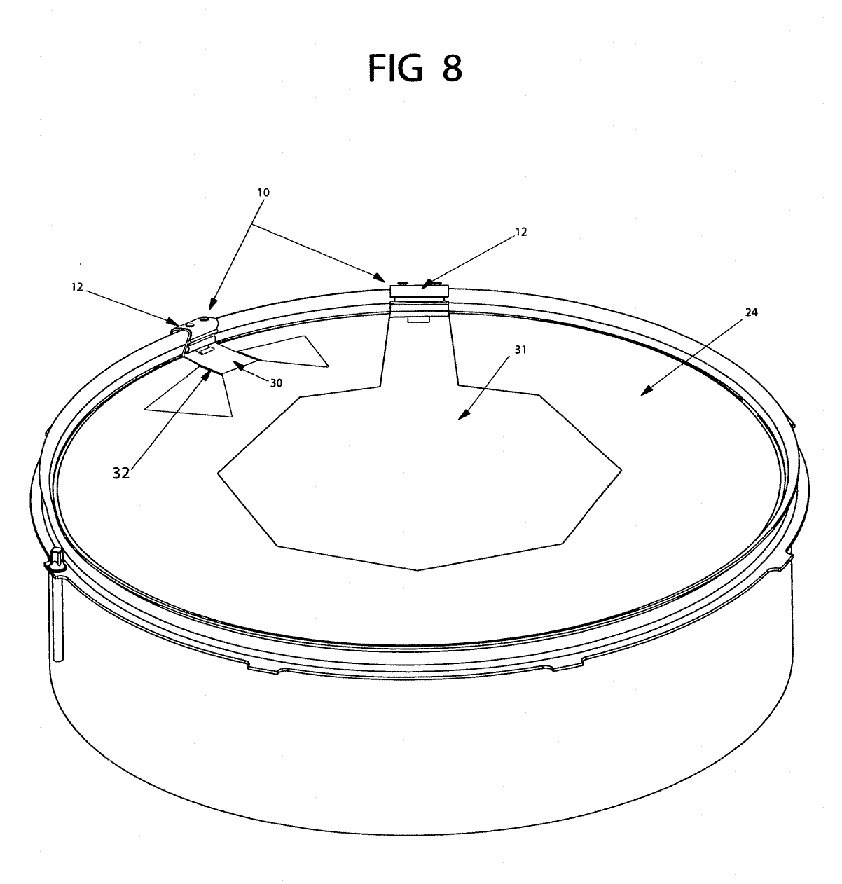

Referring now to FIG. 8; still referring to the Snap-On Drum Clip Sound Enhancer 10 this drawing shows two alternate flexible surfaces 30 and 31. The construction details of the flexible surface 30 has creased areas 32 allowing for movement when the drumhead 24 is struck. Flexible surface 31 employs the same clip attachment as 30, but is larger in size and is meant to rest on the drumhead and be stuck itself by the drummer, changing the fundamental pitch of the drum.

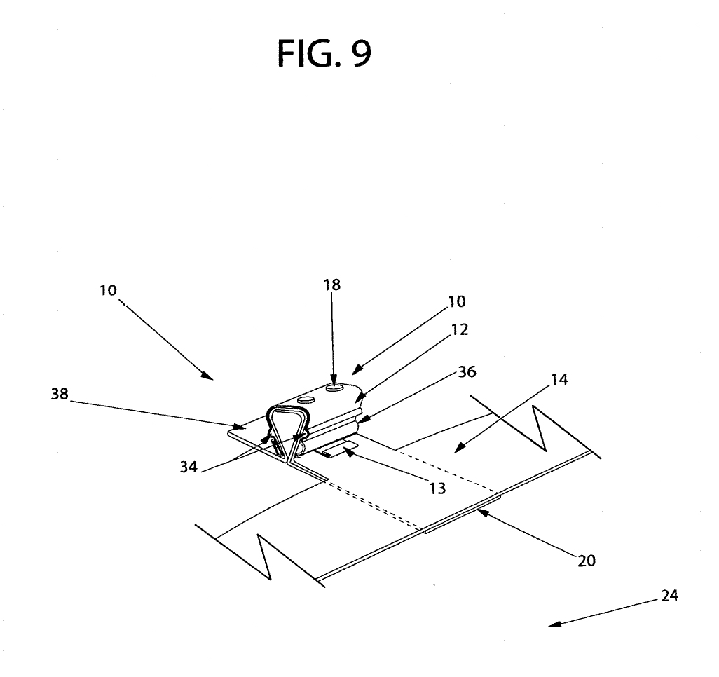

Referring now to FIG. 9; this perspective close up of the Snap-On Drum Clip Sound Enhancer 10 shows the clip 12 in a closed position; the leather and/or plastic flexible surface material 14 and/or 20 run under the clip 12. The flexible surface material 14 and 20 are die-cut with 2 holes as to accept the rivets 16 from under flexible surface material 14 and 20 for fastening to clip 12. When opening the clip for installation, grooves 34 are used to spread open clip 12 enough to get flexible material 14 and 20 with male rivets 16 into holes of clip 12. Once clip 12 is open enough to accept dampening material, the top rivets are added and stamped closed. The installation grooves 34 are no longer necessary and the opening of the clip 12 is now transferred to pulling tab 38 and flexible surface material 14 apart and securing over the rim of the drum. The rolled metal 36 of clip 12 is designed to prevent the flexible surface material 14 from being damaged over time by sharp metal edges. Protrusion 13 is designed to prevent the clip from becoming stuck between the drumhead and the drum hoop.

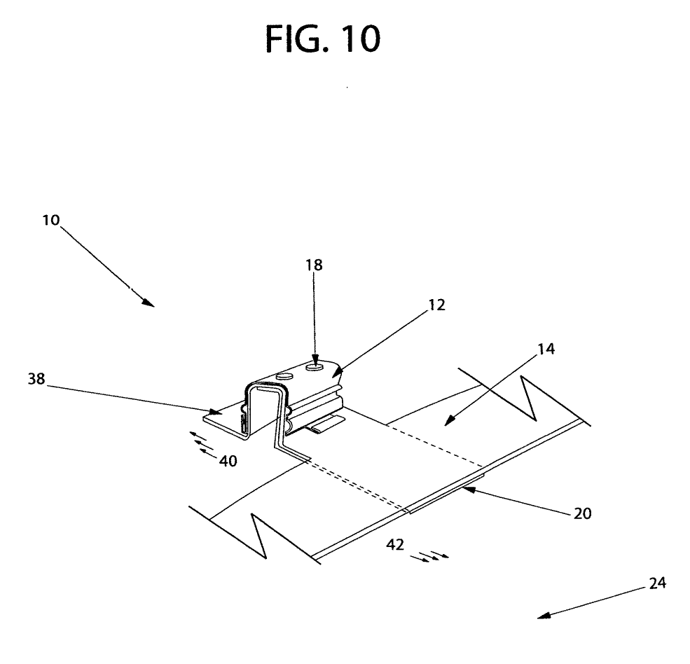

Referring now to FIG. 10; the Snap-On Drum Clip Sound Enhancer 10 here shows a perspective close up of the clip 12 in an open position; it shows the clip 12 being pulled apart with tab 38 and flexible surface material 14. This creates an opposing force 40 and 42 that along with the binding of clip 12 to flexible material 14 via rivets 16, the ridged clip 12 opens as the energy is transferred to the opposing ends of clip 12. Once the ridged clip 12 is open, it can be selectively attached to any part of a drum rim.

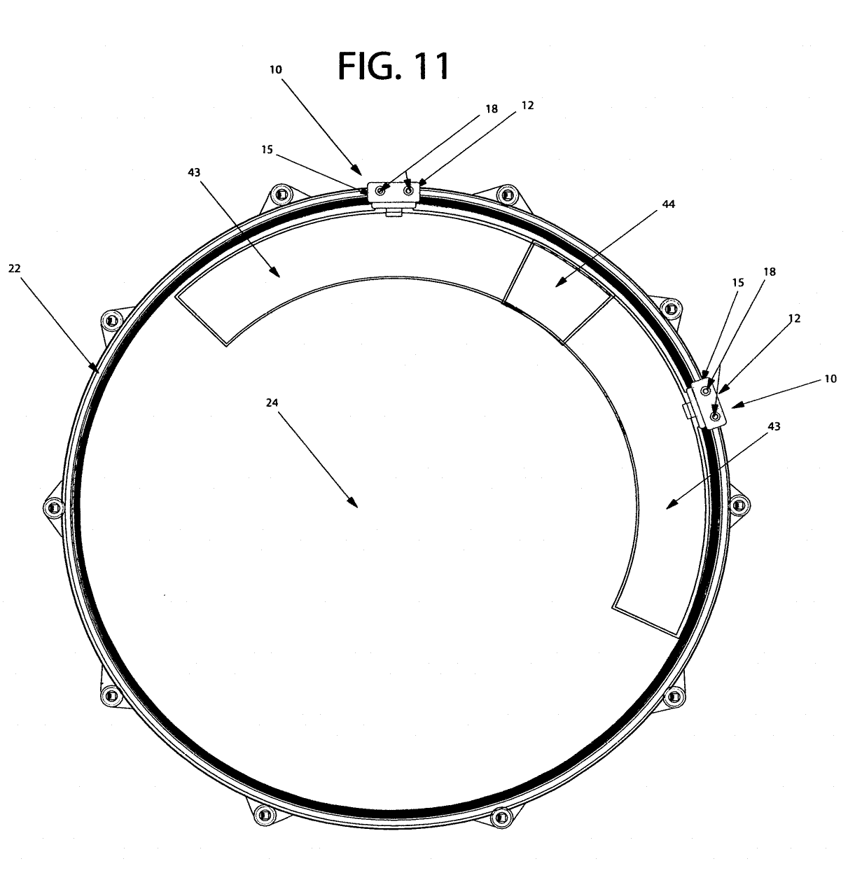

Referring now to FIG. 11; is a top view showing another embodiment of the Snap-On Drum Clip Sound Enhancer 10 resting on the drumhead 24 utilizing the snap on clips 12. These alternate plastic flexible surfaces 43 have different thickness and can be attached to the drum rim 22 at the same time or stand alone for different dampening effects when the drumhead 24 is played. These two flexible surfaces can overlap 44 at the discretion of the drummer to give a thicker combined surface area, thus increasing dampening properties to the drumhead 24 when struck. The construction details are as follows for both of the shown Snap-On Drum Clip Sound Enhancer 10 embodiments: two clips 12, two PET film plastic flexible surfaces 14, two leather or friction based materials 15 under the clips 12, twelve rivets 18 attaching flexible surfaces 14 to friction based materials 15 to clips 12.

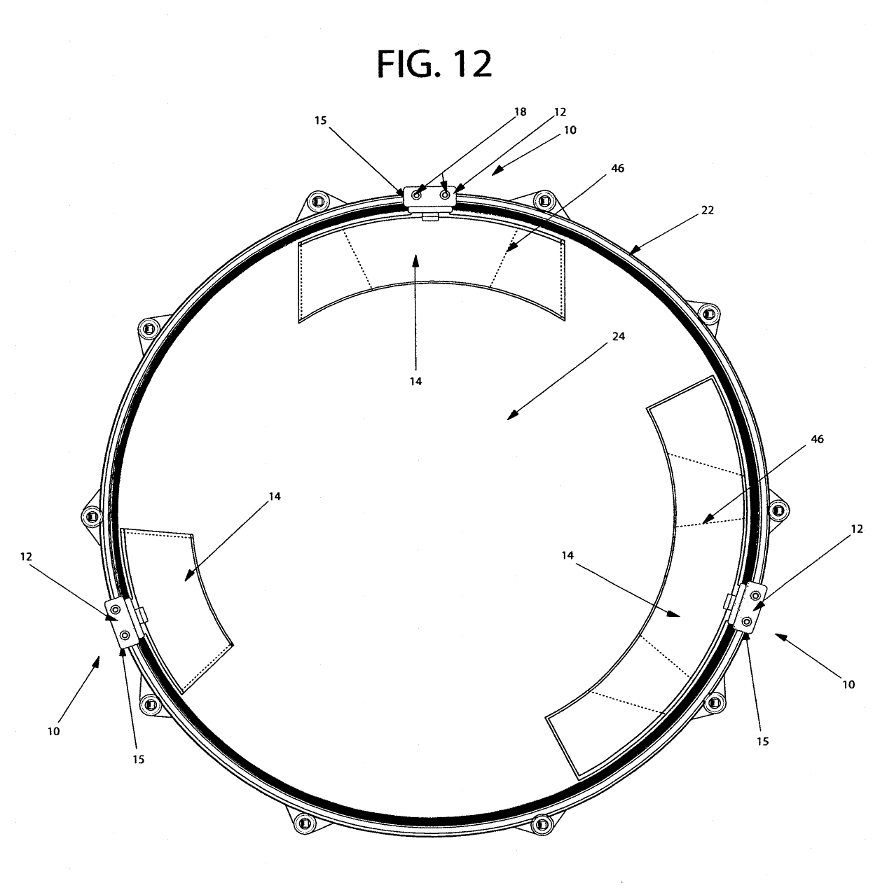

Referring now to FIG. 12; is a top view showing three separate embodiments of the Snap-On Drum Clip Sound Enhancer 10 resting on the drumhead 24 utilizing the clips 12. All three plastic flexible surfaces 14 are marked with dotted lines 46. These show the drummer where to cut the damper to make them smaller for less dampening, or where to cut the damper shorter to fit on smaller sized drums. The flexible surfaces 14 can also be moved to different locations around the hoop 22 for more options. The construction details are as follows for each of these shown Snap-On Drum Clip Sound Enhancer 10 embodiments: three clips 12, three PET film plastic flexible surfaces 14, three leather or friction based materials 15 under the clips 12, eighteen rivets 18 attaching flexible surfaces 14 to friction based materials 15 to clips 12.

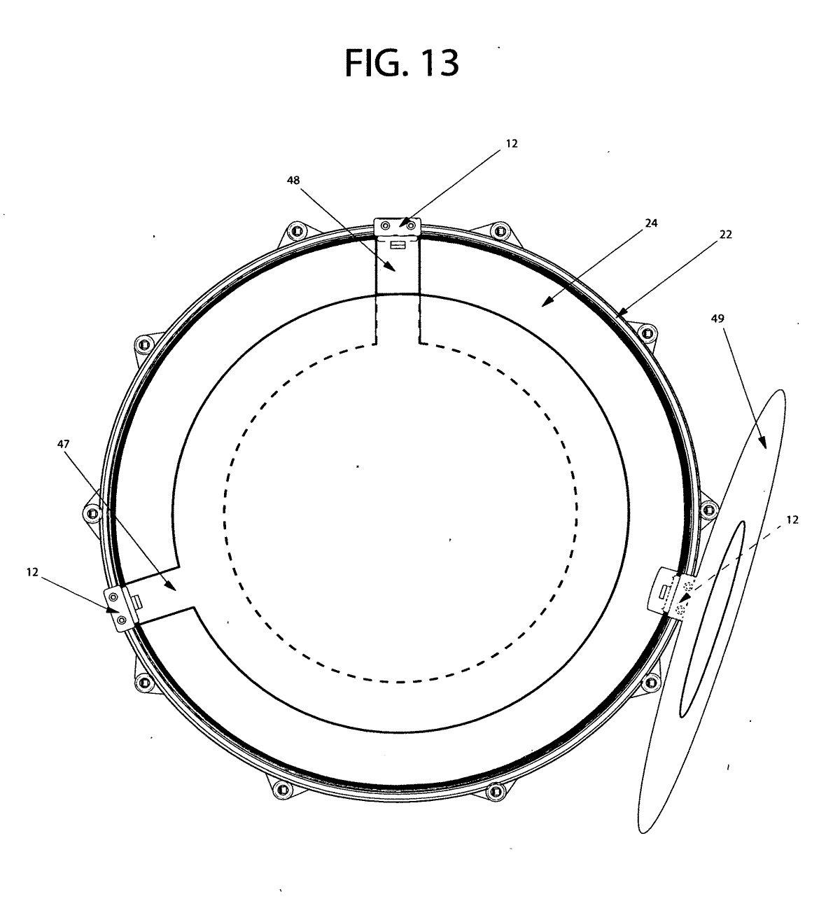

Referring now to FIG. 13; is a top view showing another three separate embodiments of the Snap-On Drum Clip Sound Enhancer 10 resting on the drumhead 24 utilizing the clips 12 to secure them to the rim 22. This drawing shows three large PET film plastic flexible surface materials used to alter the pitch of the drumhead 24 when this flexible surface itself is struck by the drummer. These larger flexible surfaces 47 and 48, are intended to be struck by the drummer saving wear on the original drumhead 24 and lowering the fundamental drum pitch determined by thickness and/or circumference of the flexible surface material. These larger flexible surface materials can stand alone or be placed on top of each other to create the desired lower pitch as well as be quickly removed from the drumhead 24 completely utilizing the clip 12 feature and gravity to keep them off and to the side of the drum. The flexible surface 49 is shown resting off the drum. The order in which 47, 48, 49 are placed, can also make changes to the pitch of the drum when struck by the player. Utilizing the different shapes and thicknesses of these flexible surfaces 47, 48, 49 will lower the pitch and help control ringing of the drum when struck. The construction details of these alternative versions of the Snap-On Drum Clip Sound Enhancer 10 embodiments are as follows: three clips 12, three PET film plastic flexible surfaces 14, three leather or friction based materials 15 under the clip 12, eighteen rivets 18 attaching flexible surfaces 14 to friction based materials 15 to clips 12.

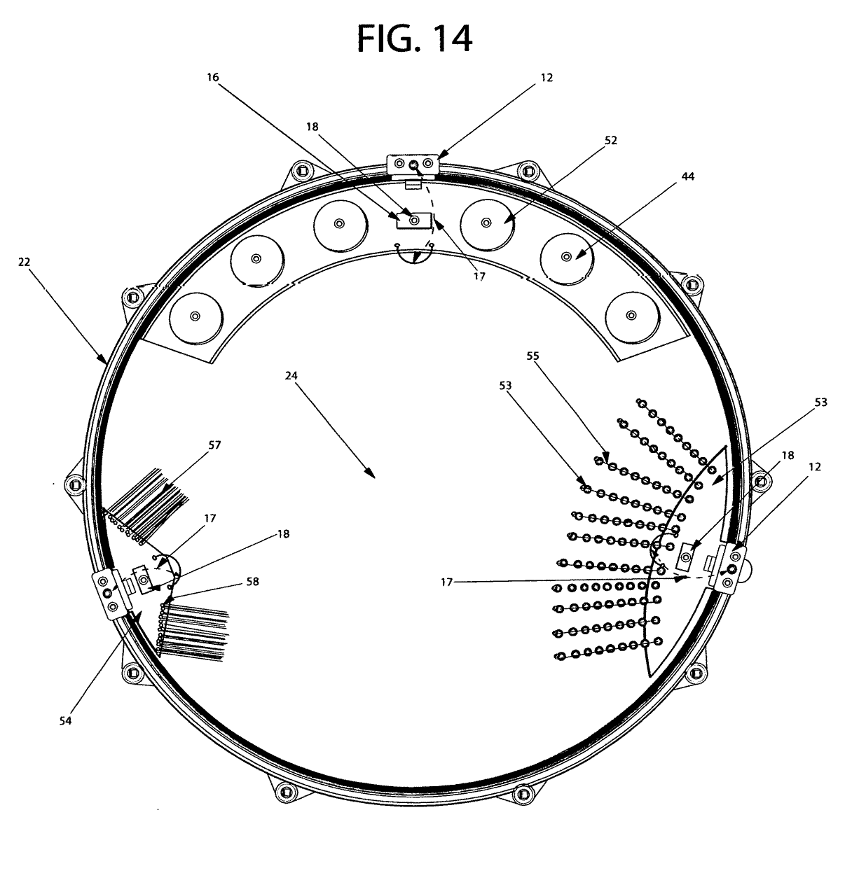

Referring now to FIG. 14; is a top view showing another group of embodiments utilizing the snap on clip 12. These embodiments includes three sound enhancers 52, 53, 54 all resting on the drumhead 24. Sound enhancer 52 is a tambourine. Sound enhancer 53 are beads. Sound enhancer 54 is snare strainer wire. These enhancers attach via the snap on clip 12 and alter the sound of the drum when the drumhead 24 is struck.

Sound enhancer 52 tambourine construction details are as follows: One flexible surface 14, one leather or friction based material 15 under the clip 12, twelve rivets 18 twelve metal tambourine jingles 52 stacked in rows of two held by rivets 18 magnet 16 held on with rivet 18 or hook and loop 17 for storage.

Sound enhancer beads 53 construction details are as follows: One flexible surface 14, one leather or friction based material 15 under the clip 12 six rivets 18 attached to clip 12, a group of wood, plastic, and or metal beads 53 string or wire 55, magnet 16 or hook and loop for storage 17.

The sound enhancer snare strainer 54 construction details are as follows: One flexible surface 14, one leather or friction based material 15 under the clip 12 six rivets 18 attached to clip 12, a group of snare strainer wire 57 solder joints 58 magnet 16 or hook and loop for storage 17.

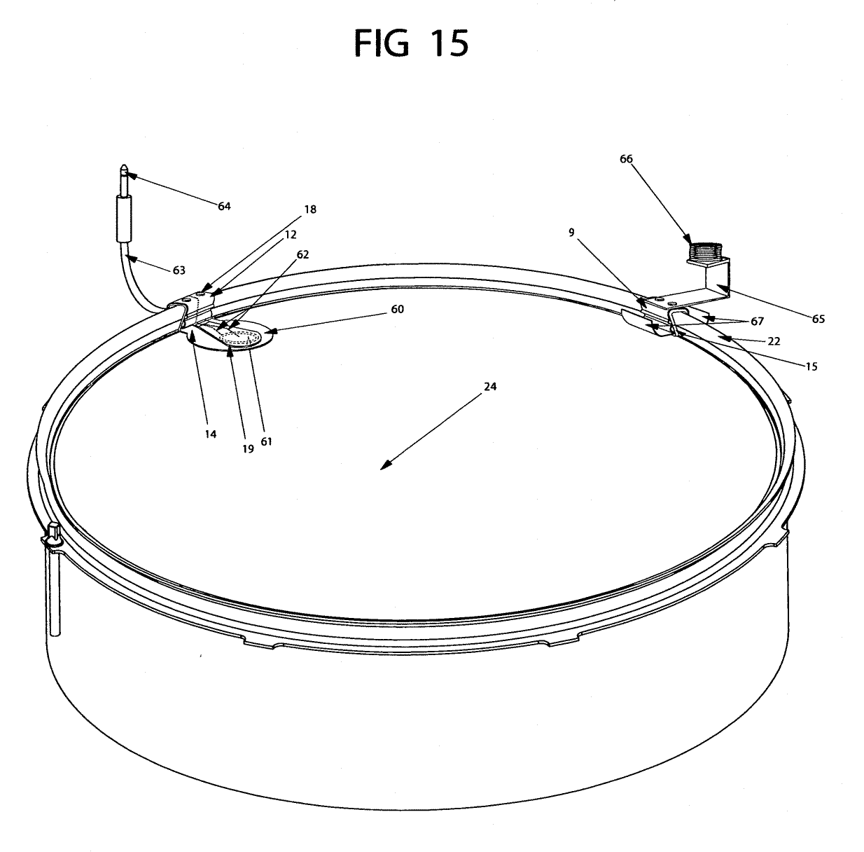

Referring now to FIG. 15; is a perspective view showing two other embodiments utilizing the snap on clip 12 and alternate clip 9. This first embodiment includes a drum trigger 60 that comes in contact with the drumhead 24. The diaphragm 61 senses the pulse of the drum hits from the drummer to the drumhead 24, it then sends an electronic pulse to the two wires 62 up and out to the cable 63 soldered to the metal jack 64 to be plugged in to an external sound source. Sound modifier drum trigger 60 construction details are as follows: One flexible surface 14, one harder surface 19 one leather or friction based material 15 under the clip 12 six rivets 18 attached to clip 12, one diaphragm 61 two wires 62 one extension cable 63 one male output jack 64. The second embodiment includes an alternative clip 9 with one or more protruding shapes 67. This alternate clip 9 is comprised of one or more ridged materials, preferably spring steal, with one or more protruding shapes 67 used to pinch the clip 9 to unlock or lock devices' grip from hoop 22. Also shown is a bracket 65 attached to a threaded microphone adaptor 66 for securing a microphone clip. The friction based material 15 grips the alternate clip 9 to the hoop 22 in the same way as clip 12.

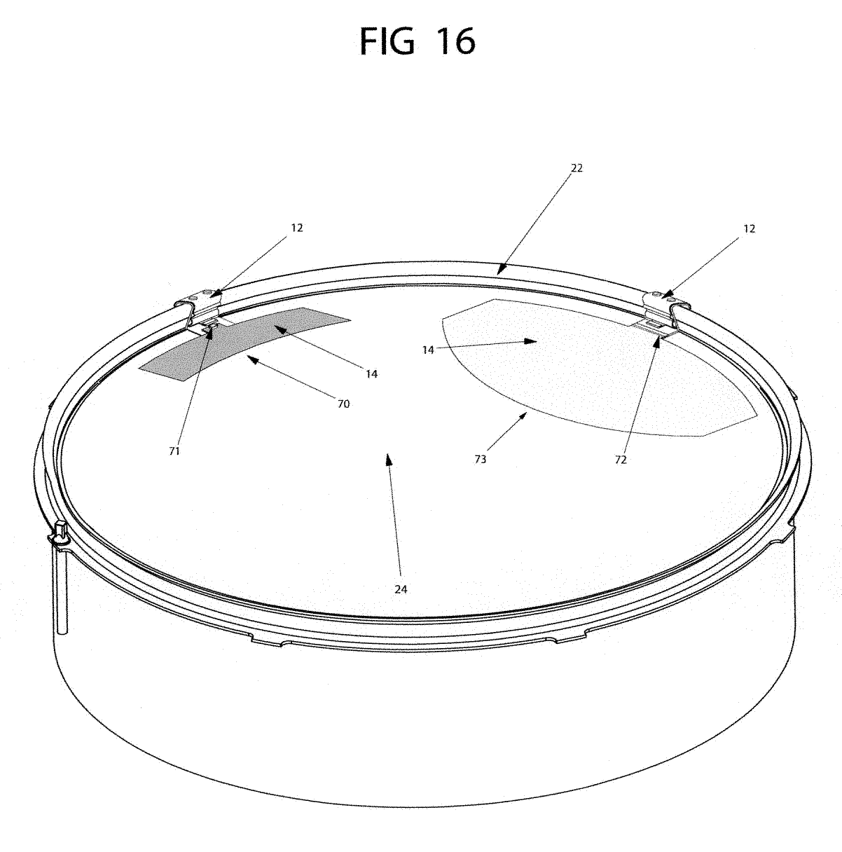

Referring now to FIG. 16; is a perspective view showing two other embodiments utilizing the snap on clip 12. The first embodiment 70 includes a button feature 71 attaching to flexible surface 14 for easy replacement of the flexible surface. The second embodiment 73 includes a hook and loop feature 72 attaching to flexible surface 14 for easy replacement of the flexible surface.

### Method of Use

Pick a spot on the vibrating surface to begin implementing the Snap-On Drum Clip Sound Enhancer. Attach the Snap-On Clip to the rim of the drum, using the tab in the back of the clip to pull apart the clip and fit it over the rim of the drum hoop and release. Push the clip down until the sound enhancer surface makes full contact with the drum skin. Play the drum and listen for the desired sound change. Try moving the clip to different positions on the drum hoop to test for desired sound altering effects before attempting the other sound options. Choose different options including: a flexible damper to get rid of, or lessen the natural ring of the drumhead, an expressive damper for controlling how much dampening is needed depending on the strength of drum hits, a pitch changing flexible damper that lowers the pitch of the drum by quarter tones, a drum trigger to send a pulse to a prerecorded external sound source, a tambourine or bead sound to enhance an existing drum sound, or a snare strainer to add high frequencies to a dull drum. Try them individually or in combination depending on the song.

With soft playing, the flexible dampening leather surface model will move very little when the drum's vibrating surface is struck. With hard playing the flexible dampening surface will lift off the vibrating surface for a more open and “expressive” drum sound, matching the drummers' natural dynamics. To control the amount of dampening: The flexible dampening surface is comprised of two wings, one on each side of the clip. Leave both wings flat against the drum head for the most dramatic sound modification. To decrease the amount of dampening, fold one wing of the dampener so that the corner rivet and center magnet come together to attach. This creates less overall surface contact to the drum head and will lessen the dampened effect of the drum. If the least dampening option is required, fold both left and right sides of the leather containing rivets onto the center magnet. This orientation will dampen the percussive sound very little, keeping the drum in its most lively state. For testing, tuning, storage, and, if desired, during play, flip up the entire dampening leather flap component and temporarily attach the imbedded center magnet to any part of the ferrous metal clip. The damper is now completely off the drumhead, and will not change the sound of the drum. This allows the drummer to quickly go back to the original unaltered sound of the drum, even during the same song!

### Advantages

The 1st advantage of the expressive damper is that it allows a change of dampening options depending upon how a drummer strikes the drum. By mixing different materials and working with gravity, this new flexible damper can open and close like a gate or change the pitch of the drum when played. Current dampers on the market are designed to be “all on” or “all off” the drumhead while the drummer is playing. The expressive damper reactive to the “feel” of the player in real time throw h the length of the song. The 2nd advantage is that this expressive damper is particularly robust in both construction and materials used. By choosing the right materials: the metal clip for the hoop attachment (no screws, glues or braces), the hard and soft leather, or PET film (which insures both flexibility and durability), this system will be effective despite weather conditions, and will resist breaking, lasting a longer time than other current products.

The 3rd advantage is that this expressive dampener is consistent and easily replicates the sounds desired. Once the Snap-On Drum Clip Sound Enhancer is adjusted to the sought after sound via its position on hoop of the drum, repeatability is easy. No longer will a drummer need to cut the right size tape that eventually comes off, or gel that pops off or melts during an important recording or show. They can fold or open the flexible leather of the dampening component secured with the clip on the drum hoop for long lasting play.

The 4th advantage is that the Snap-On Drum Clip Sound Enhancer can be produced for a price that makes it affordable even for beginners.

The 5th advantage is the option to taking the Sound Enhancer off the drumhead by store it on the hoop or off to the side of the drum. A drummer can quickly and easily go from a desired pitch and dampening of the drum to a state of having no pitch or dampening change at all. This is achieved by flipping up the flexible surface and securing it away from the drum head by touching the center magnet to the ferrous clip or throwing the flexible surface over the rim held on by the metal clip. A drummer can play a ringing, jazzy sound, then switch to a rock and roll “thud” tone in the middle of a song.

The 6^{th} advantage is speed of sound change. The tab extension allows for the metal clip to be easily opened and closed. This permits the clip to be quickly and easily moved to any desired position on the rim of the drum hoop where it will stay. It eliminates the age-old problem of loosening screws, gels that unstick, or extruded rubber designs that lose their springy position by bending over time and becoming loose and buzzy resting on the drum.

The 7^{th} advantage is that the Snap-On Drum Clip Sound Enhancers can add another percussive element to the snare or torn. Adding new sounds quickly to an existing snare is another big advantage for session drummers who are making up for fewer musicians in a band, or a drummer that wants more control in a live setting by adding alternative percussion sounds to the trap kit.

The 8^{th} advantage of the Snap-On Drum Clip Sound Enhancers is the option of using the drum trigger to add external sounds of any kind. This will allow the drummer to add any sound to the drum in real time to the house PA system or recording engineer at a studio, or even to himself. The drummer can supply the sound bit from his or her phone, wirelessly or by cable, or have it stored by the engineer in the control room or front sound system. The Snap-On Drum Clip with its attachment for a microphone is nice too. It will eliminate mic stands around the drum and as little mics get better and better, it will be a great addition to a kit without the clutter.

In a broad embodiment, the present device is an invention for modifying the sound made by a vibrating surface of a percussion instrument. The invention should not be limited by the above described embodiment, method, and examples, but by all embodiments and methods within the scope and spirit of the invention as claimed.

I claim:

1. (canceled)

2. The sound enhancing device of claim 1, wherein said flexible surface dampening component of the Snap-on Clip Sound Enhancer may be selectively folded so that said contact surface is reduced to a smaller second-size area which contacts said drum membrane and thereby alters, in a second manner, the vibration characteristics of said membrane when said drum is played. The Snap-on Clip Sound Enhancer may be selectively folded so that said contact surface is reduced to a smaller third-size area which contacts said drum membrane and thereby alters, in a third manner, the vibration characteristics of said membrane when said drum is played.

3. The sound enhancing device of claim 2, wherein said flexible surface dampening component of the Snap-on Clip Sound Enhancer will be held in the folded orientation described in claim 2 and/or stored off of the drumhead using magnets, hook and loop, buttons, or ferrous metal.

4. (canceled)

5. (canceled)

6. The sound enhancing device of claim 1, wherein a sound altering component of the Snap-On Clip Sound Enhancer is in the form of an electronic trigger such as one that is used to detect the vibration pulse of said drumhead when struck, sending an electronic signal to an external sound source.

7. The sound enhancing device of claim 1 wherein the sound altering component is in the form of a damper that is marked with dotted lines to later be cut by the drummer to a size and shape that works with his/her drum dimensions and drumming style.

8. The sound enhancing device of claim 1 claim 1, wherein the ridged clip component of the Snap on Clip Sound Enhancer is modified to allow for the attachment of a microphone.

9. The sound enhancing device of claim 1, wherein an alternative rigid clip is comprised of one or more rigid materials, preferably spring steal, with shaped tabs to squeeze thus pulling apart the rigid clip releasing the clip from the hoop.

10. A device for altering sounds produced by a drum instrument of the type including a membrane that is supported in a stretched state by a rigid hoop frame, device comprising:
a way to frictionally mount said device to said rigid hoop frame
a first flexible surface affixed to a second flexible surface via metal rivets
a clip opened to except the first and second flexible surface and affixed together with two metals rivets
a sound enhancing device created by the second flexible surface coming in contact to said drum membrane
a left and right tab created by the second flexible surface to efficiently open and close said clip of said device over said rigid hoop of a drum.
a device, once the clip is secured to said rigid hoop, that embodies a different second surface materials: plastic, leather, cloth, metal, wire, sand, stone to create different sounds once the said drum membrane is struck with an object by a musician.

11. The device of claim 1, wherein the clip component holds the said flexible surface in the center portion of said drum membrane, altering the center vibration of the drum when the said flexible surface is struck with an object by a musician.

12. The sound enhancing device of claim 1, wherein the clip component holds the second surface of the sound enhancement component: tambourines, bells, shakers, snare strainers, beads, fabric or metal, firmly to the rim of the drum.
